(19) United States
(12) Patent Application Publication
(10) Pub. No.: US 2011/0056143 A1
(43) Pub. Date: Mar. 10, 2011

(54) INTERMEDIATE PRODUCT FOR USE IN THE PRODUCTION OF ABRADING OR CUTTING TOOLS

(76) Inventor: Cedric Sheridan, Dondelange (LU)

(21) Appl. No.: 12/377,880

(22) PCT Filed: Aug. 31, 2007
(86) PCT No.: PCT/EP07/59103

§ 371 Date: Feb. 18, 2009

(30) Foreign Application Priority Data
Sep. 1, 2006 (EP) 06 119 978.2
Nov. 15, 2006 (EP) 06 124 110.5

(51) Int. Cl. C09K 3/14

(52) U.S. Cl. 51/303

(57) ABSTRACT

An intermediate product for use in the production of abrading or cutting tools has the form of a soft, easily deformable paste comprising powdery sinterable matrix material, binding agent and solvent for the binding agent, the paste having superabrasive particles dispersed therein, the superabrasive particles being individually encrusted within a coating of presintered material.

### TECHNICAL FIELD OF THE INVENTION

The present invention generally relates to an intermediate product for use in the production of abrading or cutting tools, in particular to such an intermediate product that can be shaped into a desired shape and subjected to high-temperature treatment for forming an abrading or cutting tool.

### BACKGROUND OF THE INVENTION

Tools for cutting and/or abrading are conventionally fabricated of a suitable matrix material with minute abrasive grains, such as diamonds, embedded within the matrix material. Basically, such tools are formed by conventional powder metallurgical techniques, wherein the abrasive grains are initially mixed with the matrix material (e.g. metals, alloys, metal carbides etc., as well as mixtures thereof) in powder form and some binding agent, after which the mixture press-moulded to bond and shape the mixture into the desired tool. In the so-called hot-pressing method, the mixture is placed in a mould having the shape of the abrasive tool to be formed and pressed at high pressure and temperature to cause sintering of the sinterable material. According to the “cold press and sinter” technique, the mixture is first pressed at high pressure into the desired tool shape and thereafter fired at high temperature in a furnace to sinter the tool. As an alternative to these compaction techniques, it is known, for instance from document EP 0 754 106 B1, to provide soft and easily deformable preforms in the form of a slurry or paste containing the matrix material in powder form, abrasive grains and some liquid binder phase. The soft and easily deformable preforms are subsequently sintered under pressure. Tools fabricated in these or similar manners are commonly referred to as metal-bonded abrading or cutting tools.

Efficiency and lifetime of an abrading or cutting tool are among others determined by the degree of uniformity of the distribution of the abrasive grains on the surface or volume of the tool and by the retention strength of the abrasive grains within the surrounding matrix material. In tools fabricated according to any of the above-described described techniques, the abrasive grains are randomly distributed, which means that some of them may be close together, possibly touch each other, while some regions of the tool may only have little density of abrasive grains. As a matter of fact, this negatively affects the cutting or abrading performance of the tool. The difficulty of uniformly distributing abrasive particles throughout the matrix material was first overcome by the method taught in U.S. Pat. No. 3,779,726. This document proposes to tumble the abrasive grains in the presence of a powder of sinterable material and binding agent while controlled amounts of water are simultaneously sprayed thereon. In this way, each abrasive particle is singularly coated with a sinterable particulate mass in such a way that granules, so-called “pellets”, are formed. These pellets are subsequently pressed into the desired shape at high pressure (35 tons per square inch, i.e. approximately 5000 atmospheres), possibly after being mixed with granulated metal powder. Those skilled in the art are aware that mixing the pellets with metal powder may cause the problem of segregation between the metal powder and the pellets. Another method for individually coating abrasive grains is disclosed in U.S. Pat. No. 4,770,907. This method commences with the preparation of a slurry of a selected metal powder with a binding agent dissolved in an organic solvent in predetermined relative concentrations. The abrasive grain cores are then fluidized in a work vessel and the slurry is sprayed onto the abrasive grains cores during fluidization, whereby a generally uniform coating of the slurry builds and dries on each abrasive grain.

### BRIEF SUMMARY OF THE INVENTION

According to the invention, an intermediate product for use in the production of abrading or cutting tools is provided in the form of a soft, easily deformable paste comprising powdery sinterable matrix material, binding agent and solvent for the binding agent, the paste having superabrasive particles dispersed therein, the superabrasive particles being individually encrusted within a coating of presintered material.

For the purposes of the present, the terms “soft” and “easily deformable” are used in conjunction with “paste” to indicate that the paste has a consistency approximately like modelling clay, such that it could be shaped by hand. It should be noted, however, that the particles of sinterable matrix material and the superabrasive particles themselves are extremely hard and that the softness and the malleability of the paste is due to the binding agent and its solvent, which make the hard particles stick together. It shall further be noted that “superabrasive particles” in the present context may include diamonds, boron nitride particles and like particles. The term “superabrasive” is used to indicate that the encrusted particles are of increased hardness with respect to the particles of sinterable matrix material (e.g. tungsten carbide, fused tungsten carbide, tungsten carbide cobalt, nickel, tin, chromium, cobalt, bronze, copper alloy, or the like), which by some are regarded as “abrasive” particles. The terms “presintered coating” or “coating of presintered material” mean that the coatings have been subjected to a high-temperature treatment such that they form a hard crust on the superabrasive particles.

As will be appreciated, the intermediate product according to the invention facilitates the manufacture of an abrasive or cutting tool since one can easily bring it into the desired shape, e.g. by applying it to a mould and pressing it, by moulding injection or by extrusion. Once the desired shape has been reached, the intermediate product can be subjected to a high-temperature treatment for fixing the shape. Such high-temperature treatment may, for instance, comprise fusing, sintering and/or infiltration of the matrix material with a braze that bonds the matrix material and the encrusted superabrasive particles. The high-temperature treatment may be carried out under atmospheric pressure or under higher pressure (e.g. between about 30 and about 40 MPa for the “hot pressing” technique, between about 100 and about 150 MPa for the “Hot Isostatic Pressing” (HIP) technique or between about 2 and about 10 MPa for the so-called sinter-HIP technique). Because each superabrasive particle is individually surrounded with a presintered coating, the distance between two such particles corresponds to at least twice the thickness of the coatings. When the paste is pressed, injected or extruded into the mould, the presintered coating furthermore prevents a direct contact between the superabrasive particles and the mould or the walls of the extrusion/injection moulding system, which reduces damage to the latter.

Preferably, the superabrasive particles are of substantially the same size with coatings of substantially the same thickness. In some cases, it will however be considered advantageous if the superabrasive particles have a broader size distribution and/or their coatings a broader thickness distribution.

Forming of the intermediate product according to the invention may for instance be achieved by mixing the superabrasive particles, the powdery sinterable matrix material the binding agent and the solvent for the binding agent, e.g. in a blender, a mixing drum, a mixing bowl or any other suitable container. According to a first variant for mixing the different components, one forms a first mixture by mixing the powdery sinterable material and the encrusted superabrasive particles, and a second mixture by mixing binding agent and solvent for the binding agent. Subsequently, one mixes the first and second mixtures so as to form the paste. The skilled will note that in this variant, the powdery sinterable matrix material and the encrusted superabrasive particles might undergo segregation and that if this is the case, the first and second mixtures should be mixed together shortly after forming the first mixture to avoid segregation as much as possible. According to a second variant for mixing the different components one first forms a first mixture by mixing binding agent and solvent for the binding agent. On then introduces powdery sinterable matrix material into this first mixture, whereby a second mixture is formed. Encrusted superabrasive particles are then introduced into the second mixture and the resulting mixture is mixed so as to form a soft, easily deformable paste. According to a third variant for mixing the components, one first mixes the solid-state components, i.e. the superabrasive particles, the powdery sinterable matrix material and the binding agent, and then adds to the so-obtained mixture of particles the liquid solvent. The solvent can simply be poured into the particle mixture or sprayed onto the mixture until one obtains a paste of the desired consistency.

According to a preferred embodiment of the invention, the crust or coating of presintered material surrounding the superabrasive particles has porosity between 5 and 60%. It shall be understood that “porosity of the coating”, as used herein, is the ratio of the volume of pores, cracks, fissures or like cavities in the coating to the total volume of the encrusted particle. It should be noted that porosity of the coating on the superabrasive particles influences the retention strength of the latter within the finished tool. During the final high-temperature treatment of the shaped intermediate product, molten metal penetrates into pores, cracks or fissures within the crust or coating and after cooling firmly bonds the encrusted superabrasive particle to the surrounding matrix material. The porosity of the coatings is specifically important if no or only a weak metallurgical bond forms between the braze metal or the metal bond and the material of the coating. For purposes of the present, “metallurgical bond” refers to attractive forces that hold together atoms in a crystalline or metallic type structure. Little metallurgical bond e.g. forms between a coating of tungsten carbide (e.g. fused tungsten carbide, monotungsten carbide or ditungsten carbide) and brass. In this or like cases, the porosity of the coatings preferably amounts to at least 15%, so that the encrusted superabrasive particles (sometimes also referred to as “granules” or “pellets”) can be “anchored” within the matrix material. If, however, a significant metallurgical bond forms, as is the case for instance with a manganese braze and tungsten carbide coatings, the porosity may be lesser, e.g. below 10%. In any case, porosity of the coatings more preferably ranges between the above-mentioned 5 and 60%, more preferably between 10 and 50% and most preferably between 15 and 50%.

According to another preferred embodiment of the invention, the binding agent and the solvent together represent between 20 and 80% and more preferably between 30 and 70% of the volume of the paste. The binding agent preferably comprises or consists of a cellulose ether, most preferably methylcellulose and/or ethylcellulose, whereas the solvent for the binding agent preferably comprises water or an organic solvent such as, for instance, an alcohol or an acetale. Preferably, the solvent has an elevated boiling point, i.e. above 100° C. It has been found that glycerol formal (boiling point between 191 and 195° C.) and 2,5,7,10-tetraoxaundecane (boiling point about 200° C.) are particularly well suited as solvent, e.g. for methylcellulose, because of their high solvent power. Those skilled will note that during the high-temperature treatment of the shaped intermediate product, the solvent and the binding agent evaporate or decompose into gaseous matter and are evacuated from the solidifying paste. This is accompanied, e.g. in the hipping technique, by a reduction of the volume of the intermediate product. For instance in the infiltration technique, however, the volume occupied by the solvent and the binding agent thus corresponds approximately to the volume which can be occupied by a braze or molten metal during the high-temperature treatment. The proportion of binding agent and solvent with respect to the matrix material thus determines the compactness of the matrix material. It is worthwhile noting that if, on the one hand, the proportion of binding agent and solvent is chosen too high, e.g. above 80%, the pores and cavities formed during evaporation may become so large that infiltration of the matrix material by molten metal may not be efficient. On the other hand, if the amount of binding agent and solvent is too low e.g. below 20%, this might also negatively affect infiltration. It has been found that a proportion of binding agent and solvent in the above-mentioned ranges achieves best results.

Those skilled will furthermore appreciate that the choice of methylcellulose and/or ethylcellulose as binding agent and glycerol formal and/or 2,5,7,10-tetraoxaundecane as solvent present several advantages, in particular: (a) rapid dissolution of the binding agent by the solvent at room temperatures, (b) chemical inertness with respect to the particles of sinterable material and the abrasive particles, in particular no oxidation of metallic particles, (c) lasting consistency of the paste due to the low volatility of the solvent, (d) nearly residue-free vanishing of the binding agent/solvent during the high-temperature treatment (methylcellulose, ethylcellulose, glycerol formal and 2,5,7,10-tetraoxaundecane evaporate easily at temperatures above 500-600° C.). (a) implies, in particular, that mixing of the paste may be achieved at room temperature, and (c) that the paste could e.g. be stored during longer time (e.g. several weeks) without significant loss of malleability. The paste furthermore can easily be shipped to an end user, e.g. a tool manufacturer. Last but not least, since if the paste does not dry quickly, it is usually without significant consequences if someone inadvertently leaves the paste container open over night.

### BRIEF DESCRIPTION OF THE DRAWINGS

Further details and advantages of the present invention will be apparent from the following detailed description of not limiting embodiments with reference to the attached drawings, wherein:

FIG. 1 is a schematic illustration of an intermediate product according to the present invention;

FIG. 2 is a schematic illustration of a method for forming superabrasive particles encrusted within a coating of sintered material;

FIG. 3 is a schematic illustration of a method for fabricating an intermediate product according to the present invention;

FIG. 4 is a schematic illustration of a possible process for forming an abrading or cutting tool using the easily deformable paste.

### DETAILED DESCRIPTION OF THE PREFERRED EMBODIMENTS

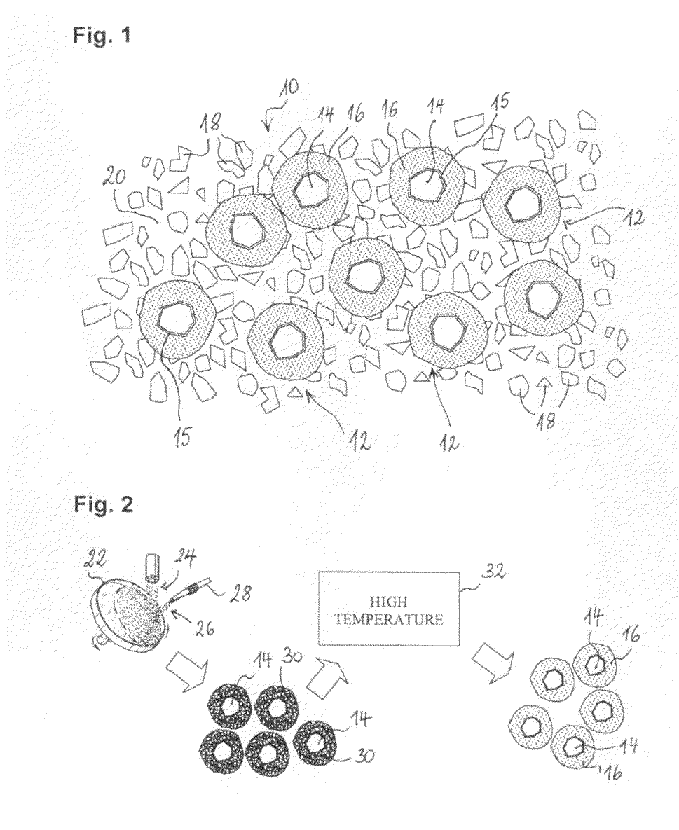

FIG. 1 shows a generally soft, easily deformable particulate paste 10 for use in the production of cutting or abrading tools. The paste 10 comprises abrasive grains 12 in the form of superabrasive particles 14 (like diamonds or boron nitride particles) encrusted within a presintered, coating 16, particles of sinterable material 18 like tungsten carbide (e.g. monotungsten carbide, ditungsten carbide, fused tungsten carbide, etc.), metal particles (e.g. nickel, cobalt, iron, copper, chromium, tin, etc.) and/or metal-alloy particles (e.g. bronze, brass, cobalt alloys, nickel alloys, iron alloys, etc.) as well as binding agent dissolved in a suitable solvent. The binding agent and the solvent form a viscous, glutinous or jelly-like liquid 20 that fills the interstices between the particles 12, 18 and provides for the adhesion of the particles 12, 18 to one another.

FIG. 2 schematically shows a possible process for producing superabrasive particles 12 individually surrounded with a sintered coating 16. Superabrasive particles are provided in a rotary mixing container 22. The amount of superabrasive particles and the rotational speed of the mixing container are chosen such that the superabrasive particles roll on themselves under the action of gravity. A mixture 24 of a powder of sinterable material and a binding agent is progressively sifted onto the superabrasive particles, while a fine spray 26 of solvent for the chosen binding agent is directed thereto by nozzle 28. It should be noted that the powder of sinterable material, the binding agent and the solvent may be the same as or different from those used in the paste tot be fabricated with the coated superabrasive particles. Under the action of the solvent, the binding agent is dissolved and the powder of sinterable material agglomerates on individual superabrasive particles in form of a sticky, sinterable particulate mass 30. The so-formed granules are subjected to high-temperature treatment, schematically shown at 32, whereby the particulate mass 30 is transformed into a hard coating 16. It should be noted that the superabrasive particles 14 can be initially provided with a thin adhesion-promoting coating 15, applied e.g. in a previous chemical vapour deposition (CVD) process or any other suitable process.

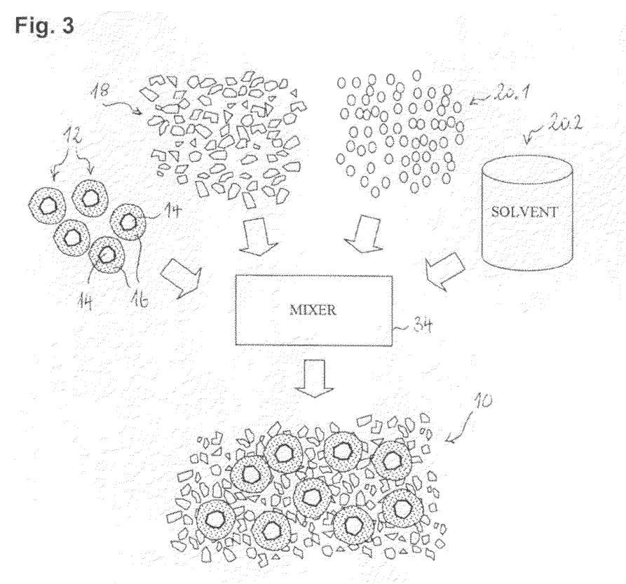

FIG. 3 schematically illustrates a process for providing an intermediate product in form of a soft, easily deformable paste 10 for the production of abrading or cutting tools. In a mixing container, shown illustratively as mixer 34, abrasive grains 12 in the form of superabrasive particles 14 encrusted within a sintered coating 16 are mixed with powdery sinterable matrix material 18, binding agent 20.1 and solvent 20.2 for the binding agent 20.1. As discussed above, the mixing of the different components of the paste 10 can be achieved in that the coated superabrasive particles 12 and the particles of sinterable matrix material 18 are mixed and that the binding agent 20.1, which has been dissolved by the solvent 20.2 in a separate container is added to the mixture of hard particles 12, 18. Alternatively, one mixes first the binding agent 20.1 and the solvent 20.2 and then separately adds the powdery sinterable matrix material 18 and the coated superabrasive particles 12. As yet a third alternative, the binding agent 20.1 can be mixed with the hard particles 12, 18 prior to the addition of the solvent 20.2. The binding agent 20.1 and the solvent 20.2 could also be added gradually and separately during the mixing process.

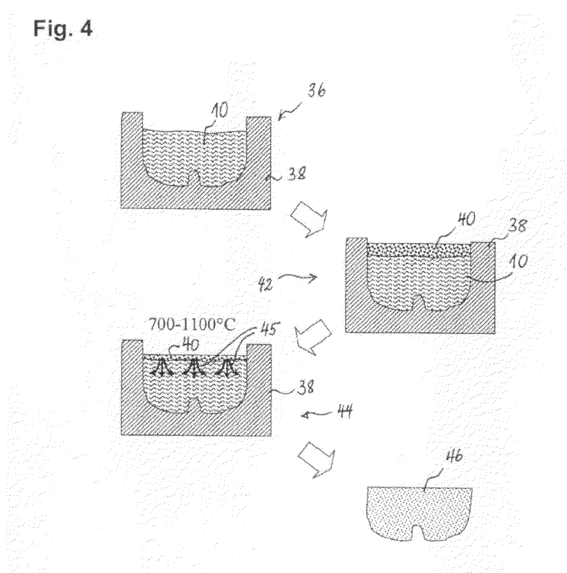

FIG. 4 schematically shows a possible process for forming an abrading or cutting tool, e.g. a drill bit, an insert for such a drill bit, a grinding wheel, a saw insert, a saw bead or the like. As shown at 36, the soft, easily deformable paste 10 is applied to a mould 38. The spreading of the paste can easily be done by hand, since the paste is about as malleable as modelling clay. Thereafter, the paste is compacted, and braze metal 40 in form of coarse powder, lump pieces or chunks is applied onto the paste 10 (shown at 42) and the temperature is raised (e.g. to 700-1100° C.) with or without the application of pressure (shown at 44). Infiltration of the braze 40 is illustrated schematically by arrows 45. After the cooling period, the finished tool 46 can be taken from the mould.

### Example 1

### WC/Co 50/50 Encrusted Diamonds Pasted with Extra Fine Co Powder

A first example of a composition of a soft, easily deformable paste for producing a cutting or abrading tool is now discussed in more detail. In this example, the paste comprises as encrusted superabrasive particles diamonds encrusted in a presintered tungsten carbide/cobalt coating.

### Preparation of the Presintered Encrusted Superabrasive Particles

The metal powder bond for the encapsulation of the diamonds was a 50/50 by weight mixture of tungsten carbide powder (Fisher Sub Sieve Size 1 μm) and cobalt powder (FSSS 1.2 μm). 300 ct (1 ct=1 carat=0.2 g) of MBS955 Si2 25/35 Mesh diamonds were coated according to the method described in U.S. Pat. No. 3,779,726. The total weight of the encapsulated diamonds before presintering amounted to 248 g.

Before presintering, the encapsulated diamonds were screened, which yielded the following particle size distribution:
0.00% wt>1.18 mm
17.34% wt>1 mm
62.91% wt>850 μm
19.75% wt>500 μm
0.00% wt<500 μm

The granules were then sintered in a Borel furnace under protective atmosphere (H2). The temperature was raised first from 18° C. to 500° C. during 60 minutes, the latter temperature was then maintained during 30 minutes. Thereafter, the temperature was further raised to 850° C. during 180 minutes, and after maintaining the temperature at 850° C. during 60 minutes, the now presintered granules were cooled down.

After presintering, the total weight of the granules amounted to 233 g, reflecting that binding agent and solvent evaporated during the sintering process. The particle size distribution after sintering was determined to:
0.00% wt>1.18 mm
9.87% wt>1 mm
65.67% wt>850 μm
24.46% wt>500 μm
0.00% wt<500 μm

The porosity of the presintered granules amounted to 29%. As mentioned already before, “porosity” as used herein designates the volume of the pores in the coating or crust of a granule, divided by the total volume of the granule (here: diamond and its presintered coating).

### Determination of Porosity

To determine the porosity of the presintered granules, a defined volume of granules (here approximately 25 cm³, no compaction of the granules) was carefully weighed, which yielded in this case 71.91 g. The granules of this probe were coated with a very thin film so that the pores were substantially sealed.

With the known density of diamond (3.52 g/cm³), we calculated the weight content of diamond in our probe:

Diamond weight in probe=(300 ct/233 g)×71.91 g×0.2 g/ct=18.52 g.

Using this result we calculated the theoretical volume of diamond in our probe as 18.52/3.52=5.26 cm³.

Using the metal bond's theoretical density (WC/Co 50/50) of 11.36 g/cm³) we calculated the theoretical volume of metal bond in our probe as (71.91−18.52)/11.36=4.70 cm³.

As total theoretical volume (without interstices and pores) of our probe we obtain 4.70+5.26=9.96 cm³.

The probe of granules coated with the sealing film were poured into a Duran beaker. Distilled water was metered in up to a level of 30 cm³, while the beaker was gently tapped and the granules smoothly agitated to eliminate air bubbles. The amount of water needed to fill the beaker up to the desired level corresponds to the volume of the presintered granules (without the interstices between them). In our case, 16 cm³ of water were added, the actual volume of the granules thus was 14 cm³. It should be noted that because of the thin sealing film, water could not penetrate into the pores of the granules. The porosity can now easily be calculated as the ratio of the difference between the actual and the theoretical volumes of the presintered granules to the actual volume. In our case, the calculation yields: (14−9.96)/14=29%.

In our case, the pores of the granules were closed in the following way. 1 g of ethylcellulose available from Dow under trade designation Ethocel™ Std 100 FP Premium was dissolved in 40 ml of acetone. To achieve complete dissolution, the mixture was agitated and then made rest for about 45 minutes until the solution was clear and free of air bubbles. The probe of 71.91 g of presintered granules was then smoothly poured into the solution. To eliminate air bubbles captured between the granules and to allow penetration of the solution into the pores of the granules, the solution with the granules was gently agitated and thereafter made rest for 15 minutes until all bubbles had disappeared. The granules contained in the solution were then poured onto a sieve of 300 Mesh and dried on the sieve. To avoid formation of agglomerates of granules or adhesion thereof on the sieve, they were gently rolled on the sieve with a finger during the drying. When the granules were very close to be completely dried, they were poured again onto a sieve of 1 mm and sieved to make sure that no granules were sticking to one another. (This operation may be repeated several times until the granules do not stick to one another any longer.) The granules were now coated with a very thin film of Ethocel™.

It should be noted that the determination of the porosity could also be achieved using Archimedes' principle. According to this method, a plurality of coated superabrasive particles are embedded within a resin (preferably a transparent one, such as e.g. epoxy or polyester resin), which must not enter the pores of the granules. Embedding of the granules should be done very carefully so as to avoid any air bubbles between the granules. The resin is then cured and the overall density of the block is determined using Archimedes' principle. Knowing the weight of the diamonds, the coatings, the resin as well as the respective densities, one can calculate the porosity. The latter method allows achieving higher accuracy in porosity determination if it is carefully executed, i.e. if air bubbles are carefully avoided. The drawback is that it takes much longer.

### Preparation of a Paste at FEPA C50 (12.50% Vol of Diamonds) with Extra Fine Co Powder

An illustrative calculation of the weight of granules of the above-described type for achieving a diamond concentration of 12.50% vol in 25 cm³ of malleable paste is discussed. Let the following notation apply:
X=diamond weight (to be determined) in the paste, and
Y=weight of the granules (to be determined) in the paste.

Required volume of diamonds=25×12.50%=3.125 cm³. X is determined as X=3.125×3.52=11 g or 55 ct. This yields for Y: Y=55×(233/300)=42.72 g.

The 25 ml of paste were produced using 42.72 g of the above-described granules, 40 g of extra fine Co powder, 1 g of Ethocel 100 FP premium (trade designation) and 16 ml of butylal. The ingredients were mixed in a bowl until a malleable paste was obtained. The 25 cm³ bucket was filled with the paste to check that the paste filled entirely the volume of the bucket.

### Example 2

### Co Encrusted Diamonds Pasted with carbonyl Fe Type CN Powder

### Preparation of the Presintered Encrusted Superabrasive Particles

The metal powder bond for the encapsulation of the diamonds in this case consisted of cobalt powder (Co, FSSS 1.2 μm). 500 ct of MBS960 Ti2 20/25 Mesh diamonds were coated according to the method described in U.S. Pat. No. 3,779,726. The total weight of the encapsulated diamonds before presintering amounted to 301 g.

Particle size distribution before presintering:
0.00% wt>1.40 mm
24.25% wt>1.18 mm
71.43% wt>1.00 μm
4.32% wt>850 μm
0.00% wt<850 μm

Presintering conditions: Borel furnace under protective atmosphere (H2). Presintering cycle:
Heating from 18 to500° C. during 60 minutes
Maintaining 500° C. during 30 minutes
Heating from 500 to 850° C. during 180 minutes
Maintaining the temperature of 850° C. during 60 minutes
Cooling down

After the presintering step, the particle size distribution was determined as:
0.00% wt>1.40 mm
0.35% wt>1.18 mm
36.17% wt>1.00 μm
63.38% wt>850 μm
0.10% wt>710 μm
0.00% wt<710 μm

The total weight of the encapsulated diamonds after presintering was 282 g.

### Determination of Porosity

The porosity of the presintered granules was determined in the same way as in example 1. In this case, an uncompacted 25 cm³ probe of the granules weighed 77.77 g.

For preparing the solution for closing the pores of the granules 1 g Ethocel™ Std 100 FP Premium and 40 ml of acetone were mixed. The mixture of Ethocel™ and acetone was agitated for complete dilution, then made rest for 45 minutes time until the solution was clear and free of air bubbles. The probe of 77.77 g of granules was then smoothly poured into the solution, gently agitated to eliminate all air bubbles and made rest for 15 minutes until all bubbles had disappeared. The granules were then poured onto a sieve of 300 Mesh and dried, whereby they were rolled with a finger. When the granules were close to be completely dried, they were sieved with a sieve of 1.18 mm. This operation was repeated until the granules did not stick to one another any longer.

In this case, the metal bond theoretical density was 8.9 g/cm³. The diamond content in the probe was 77.77×500/282)×0.2=27.58 g. The theoretical volume of the diamonds was 27.58/3.52=7.84 cm³ and the theoretical volume of the metal bond (77.77−27.58)/8.9=5.64 cm³. The total theoretical volume of the granules at full density thus yielded to be 7.84+5.64=13.48 cm³.

The sealed granules were poured into a Duran beaker, which was thereafter filled up to the level of 30 cm³. The amount of water needed in this example was 14.5 cm³. The actual volume of the granules thus was 30−14.50=15.50 cm³.

It followed: porosity of the granules=(15.50−13.48)/15.50=13% vol.

### Preparation of a Paste at FEPA C100 (25% Vol of Diamonds) with Carbonyl Iron Type CN Powder

Using these granules, a paste at FEPA C100 (25.00% vol of diamonds) with Carbonyl Iron type CN powder was prepared.

The calculation of the required amount of granules for diamond concentration of 25.00% vol in 25 cm³ of paste yields:

Required volume of diamonds=25×25.00%=6.25 cm³,

Amount of diamonds: 6.25×3.52=22 g or 110 ct,

Amount of granules: 110×282/500=62.04 g

The 25 ml of paste were produced using 62.04 g of the described granules, 30 g of FeCN, 1 g of Methocel™ A4M as binding agent and 11 ml of glycerol formal as solvent. The ingredients were mixed in a bowl until a malleable paste was obtained. The 25 cm³ bucket was filled with the paste to check that the paste filled entirely the volume of the bucket.

1.-11. (canceled)

12. An intermediate product for use in the production of abrading or cutting tools, characterised in that said intermediate product is a soft, easily deformable paste comprising powdery sinterable matrix material, binding agent and solvent for said binding agent, said paste having superabrasive particles dispersed therein, said superabrasive particles being individually encrusted within a coating of presintered material.

13. The intermediate product as claimed in claim 1, characterised in that said coating of presintered material has porosity between 5 and 60%.

14. The intermediate product as claimed in claim 1, characterised in that said binding agent and said solvent together represent between 20 and 80% of the volume of said intermediate product.

15. The intermediate product as claimed in claim 1, characterised in that said binding agent comprises a cellulose ether.

16. The intermediate product as claimed in claim 1, characterised in that said solvent comprises an alcohol or an acetale.

17. The intermediate product as claimed in claim 1, characterised in that said solvent comprises glycerol formal and/or tetraoxaundecane.

18. A method of forming an intermediate product for use in the production of abrading or cutting tools, comprising:
mixing superabrasive particles and powdery sinterable matrix material to form a first mixture, said superabrasive particles being individually encrusted within a coating of presintered material;
mixing binding agent and solvent for said binding agent to form a second mixture; and
mixing said first and second mixtures so as to form a soft, easily deformable paste having said encrusted superabrasive particles dispersed therein.

19. A method of forming an intermediate product for use in the production of abrading or cutting tools, comprising:
mixing binding agent and solvent for the binding agent to form a first mixture;
introducing powdery sinterable matrix material into said first mixture to form a second mixture; and
introducing superabrasive particles into said second mixture, said superabrasive particles being individually encrusted within a coating of presintered material, and mixing the so-obtained mixture so as to form a soft, easily deformable paste having said encrusted superabrasive particles dispersed therein.

20. A method of forming an intermediate product for use in the production of abrading or cutting tools, comprising
mixing superabrasive particles, powdery sinterable matrix material and binding agent to form a mixture, said superabrasive particles being individually encrusted within a coating of presintered material;
adding solvent for said binding agent to said mixture so as to form a soft, easily deformable paste having said encrusted superabrasive particles dispersed therein.

21. A method of forming an abrading or cutting tool, comprising:
providing a mould;
providing an intermediate product in the form of a soft, easily deformable paste comprising powdery sinterable matrix material, binding agent and solvent for said binding agent, said paste having superabrasive particles dispersed therein, said superabrasive particles being individually encrusted within a coating of presintered material;
applying said intermediate product to said mould to shape said intermediate product;
subjecting said shaped intermediate product to a high-temperature treatment to fix a shape thereof.

22. The method according to claim 10, wherein said high-temperature treatment comprises at least one of
infiltration of said matrix material with a braze, and
sintering to bond said matrix material and said encrusted superabrasive particles.
